(19) United States
(12) Patent Application Publication
(10) Pub. No.: US 2025/0246721 A1
(43) Pub. Date: Jul. 31, 2025

(54) THERMAL SUPPRESSION SYSTEMS FOR USE WITHIN TRACTION BATTERY PACKS

(71) Applicant: FORD GLOBAL TECHNOLOGIES, LLC, Dearborn, MI (US)

(72) Inventors: Bhaskara Rao Boddakayala, Troy, MI (US); Di Zhu, Novi, MI (US)

(21) Appl. No.: 18/425,120

(22) Filed: Jan. 29, 2024

(51) Int. Cl. H01M 10/658; H01M 10/613; H01M 10/625; H01M 50/249; H01M 50/507

(52) U.S. Cl. CPC H01M 10/658; H01M 10/613; H01M 10/625; H01M 50/507; H01M 50/249

(57) ABSTRACT

Thermal suppression systems are provided for use within traction battery packs. An exemplary thermal suppression system may include one or more thermal suppression containers configured to release a thermal suppression agent when a temperature near the thermal suppression container exceeds a predefined temperature threshold. The thermal suppression agent may capture or trap particles associated with battery vent byproducts, thereby managing or even preventing the transfer of thermal energy to nearby structures.

### TECHNICAL FIELD

This disclosure relates generally to electrified vehicle traction battery packs, and more particularly to thermal suppression systems for managing the transfer of thermal energy within traction battery packs.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a battery array, and a thermal suppression container arranged within the battery array and configured to release a thermal suppression agent when a temperature near the thermal suppression container exceeds a predefined temperature threshold.

In a further non-limiting embodiment of the foregoing traction battery pack, the thermal suppression container is arranged to extend between a first cell tab terminal of a first battery cell and a second cell tab terminal of a second battery cell of the battery array.

In a further non-limiting embodiment of either of the foregoing traction battery packs, the thermal suppression container is arranged to extend between a cell tab terminal of a battery cell and a cell-to-cell barrier of the battery array.

In a further non-limiting embodiment of any of the foregoing traction battery packs, the thermal suppression container is attached to a cell-to-cell barrier of the battery array.

In a further non-limiting embodiment of any of the foregoing traction battery packs, the thermal suppression agent is contained within a housing of the thermal suppression container by a cap.

In a further non-limiting embodiment of any of the foregoing traction battery packs, the housing is configured to melt, rupture, or otherwise deform to release the thermal suppression agent.

In a further non-limiting embodiment of any of the foregoing traction battery packs, the housing includes a thinned wall section that is configured to melt, rupture, or otherwise deform prior to a non-thinned wall section of the housing to release the thermal suppression agent.

In a further non-limiting embodiment of any of the foregoing traction battery packs, the thinned wall section is made of a different material than the non-thinned wall section of the housing.

In a further non-limiting embodiment of any of the foregoing traction battery packs, the housing is made of a foam material that is configured to alter its shape in response to an expansion of a battery cell of the battery array.

In a further non-limiting embodiment of any of the foregoing traction battery packs, the housing includes a structural support.

In a further non-limiting embodiment of any of the foregoing traction battery packs, the housing includes a plurality of support feet adapted for positioning and securing the thermal suppression container within a void space of the battery array.

In a further non-limiting embodiment of any of the foregoing traction battery packs, the thermal suppression agent includes at least one of solid silica, aerogel, mica, or basalt.

In a further non-limiting embodiment of any of the foregoing traction battery packs, the thermal suppression agent includes a mixture of silica beads and dielectric fluid filled beads.

In a further non-limiting embodiment of any of the foregoing traction battery packs, the thermal suppression agent includes a mixture of silica beads, dielectric fluid filled beads, and expandable foam beads.

A traction battery pack according to another exemplary aspect of the present disclosure includes, among other things, a cell stack including a plurality of battery cells, and a bus bar module arranged to electrically connect the plurality of battery cells. The bus bar module includes a frame having a first pocket, and a first thermal suppression agent is received within the first pocket.

In a further non-limiting embodiment of the foregoing traction battery pack, the first thermal suppression agent includes at least one of solid silica, aerogel, mica, or basalt.

In a further non-limiting embodiment of either of the foregoing traction battery packs, the first thermal suppression agent includes a mixture of silica beads and dielectric fluid filled beads.

In a further non-limiting embodiment of any of the foregoing traction battery packs, the first thermal suppression agent includes a mixture of silica beads, dielectric fluid filled beads, and expandable foam beads.

In a further non-limiting embodiment of any of the foregoing traction battery packs, a second thermal suppression agent is received within a second pocket of the frame.

A method of installing a thermal suppression system within a battery array for a traction battery pack, according to another exemplary aspect of the present disclosure includes, among other things, chilling the battery array for a first amount of time, waiting for a second amount of time after chilling the battery array, and inserting a thermal suppression container into a void space of the battery array after waiting for the second amount of time.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle that includes a traction battery pack.

FIG. 2 is a top view of a battery array of a traction battery pack.

FIGS. 3 and 4 illustrate an exemplary thermal suppression container of a thermal suppression system.

FIGS. 5 and 6 illustrate another exemplary thermal suppression container.

FIGS. 7 and 8 illustrate another exemplary thermal suppression container.

FIGS. 9 and 10 illustrate another exemplary thermal suppression container.

FIGS. 11, 12, and 13 illustrate yet another exemplary thermal suppression container.

FIGS. 14 and 15 illustrate thermal suppression containers incorporated into a cell-to-cell barrier of a battery array.

FIG. 16 illustrates a bus bar module that includes an integrated thermal suppression system.

FIG. 17 schematically illustrates a method of installing a thermal suppression system within a battery array.

### DETAILED DESCRIPTION

This disclosure details thermal suppression systems for use within traction battery packs. An exemplary thermal suppression system may include one or more thermal suppression containers configured to release a thermal suppression agent when a temperature near the thermal suppression container exceeds a predefined temperature threshold. The thermal suppression agent may capture or trap particles associated with battery vent byproducts, thereby managing or even preventing the transfer of thermal energy to nearby structures. These and other features are discussed in greater detail in the following paragraphs of this detailed description.

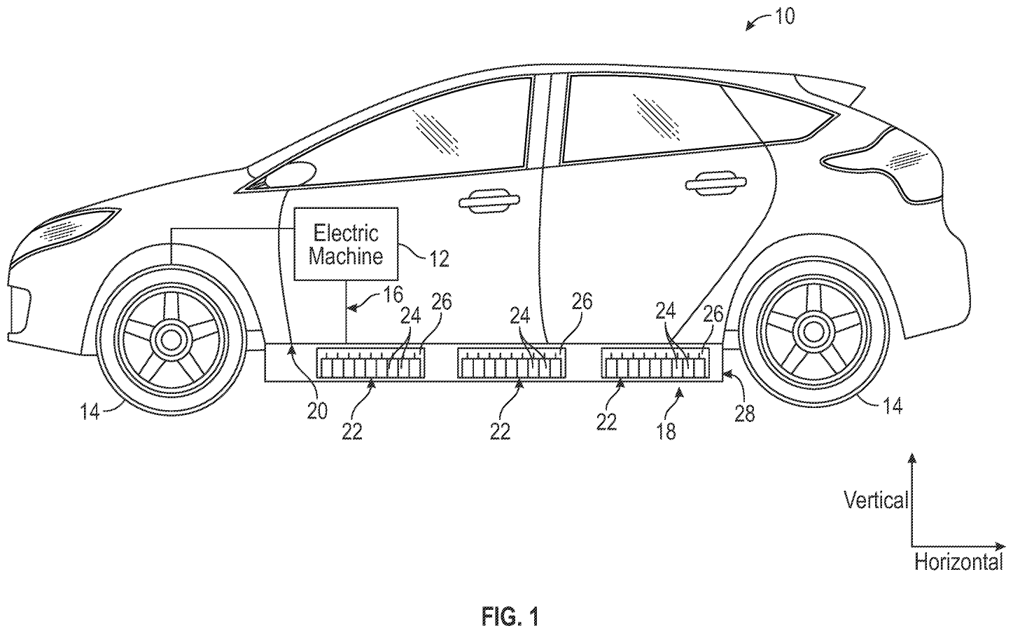

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

One or more of the battery cells 24 can periodically release vent byproducts, such as during an overcharge condition, an overdischarging condition, a short circuit, etc. The vent byproducts can be released from the battery cells 24 through a vent. Pressure increases within one of the battery cells 24 can cause the vent to rupture, thereby creating a path for the vent byproducts to be released from inside the battery cell 24. This disclosure is primarily directed to thermal suppression systems designed for managing the transfer of thermal energy when one or more of the battery cells 24 release vent byproducts.

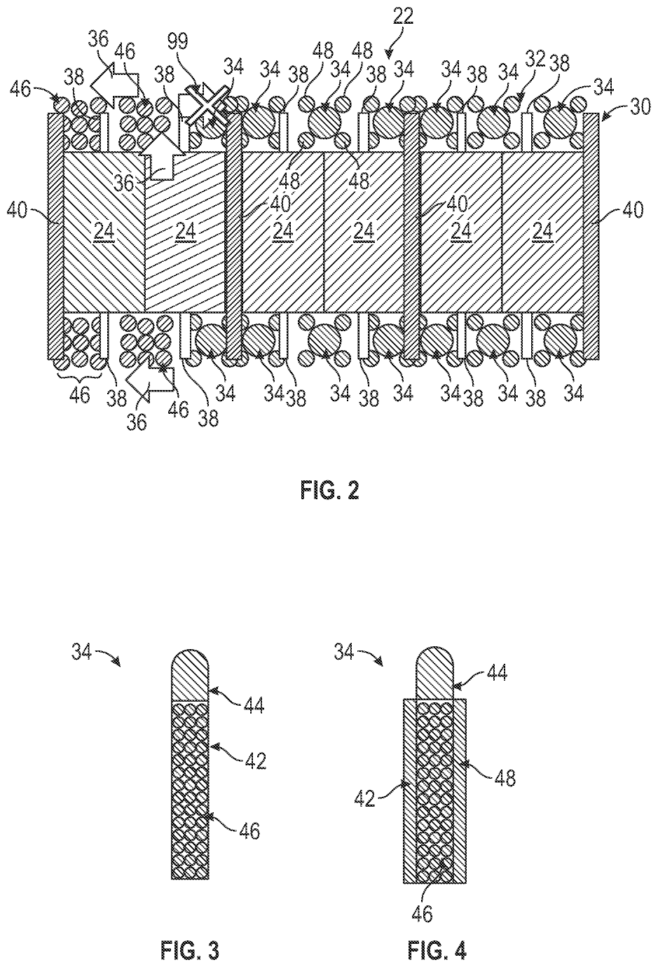

FIG. 2 illustrates select portions of a battery array 22 of the traction battery pack 18. As explained in further detail below, the battery array 22 may incorporate features designed for managing the cell-to-cell transfer of thermal energy across the battery array 22.

The battery array 22 may include a plurality of battery cells 24. The total number of battery cells 24 provided within the battery array 22 could vary and is not intended to limit this disclosure. The battery cells 24 may be grouped together in a cell stack 30. The cell stack 30 may further include one or more cell-to-cell barriers 40 that can be arranged between adjacent battery cells 24 of the cell stack 30. Although not specifically shown for the sake of simplicity and clarity, an array enclosure (e.g., top plate, bottom plate, end plates, side plates, etc.) of the battery array 22 may be arranged to substantially surround the cell stack 30.

The battery array 22 may further include a thermal suppression system 32 for managing the transfer of thermal energy across the cell stack 30. The thermal suppression system 32 may include a plurality of thermal suppression containers 34 that can be strategically positioned within the battery array 22 for managing the transfer of thermal energy during venting events. For example, among other benefits, the thermal suppression containers 34 may be configured to mitigate the cell-to-cell and/or array-to-array transfer of thermal energy when one or more of the battery cells 24 within the cell stack 30 release vent byproducts 36.

Each thermal suppression container 34 of the thermal suppression system 32 may be arranged within a void space located within the battery array 22. In an embodiment, at least some of the thermal suppression containers 34 are positioned between cell tab terminals 38 of adjacent battery cells 24. In another embodiment, at least some of the thermal suppression containers 34 are positioned between the cell tab terminal 38 of one of the battery cells 24 and one of the cell-to-cell barriers 40 of the cell stack 30. However, other arrangements are contemplated within the scope of this disclosure, and it should be understood that the thermal suppression containers 34 could be arranged within any void space of the battery array 22 where it is desirable to limit the transfer of thermal energy.

Referring now to FIGS. 3 and 4 (with continued reference to FIG. 2), each thermal suppression container 34 may include a housing 42, a cap 44, and a thermal suppression agent 46 contained within the housing 42 by the cap 44. The housing 42 may include any shape (e.g., cylindrical, rectangular, spherical, etc.) and may be made of a suitable polymeric material (e.g., polypropylene, polyethylene, etc.). The housing 42 may include support feet 48 that aid in positioning and securing the thermal suppression container 34 within the desired void space (e.g., between adjacent cell tab terminals 38) of the battery array 22.

The cap 44 may include any shape (e.g., oval, long oval, trapezoidal, etc.) and may be made from either the same material or a different material than the housing 42. The cap 44 may be made of polypropylene, silicone, ethylene propylene diene monomer (EPDM) rubber, thermoplastic elastomer (TPE), etc.

The thermal suppression agent 46 may be held within a hollow interior volume established by the housing 42. The thermal suppression agent 46 may be made of a high temperature material such as solid silica, aerogel, mica, basalt, etc. The thermal suppression agent 46 may be provided in either bead or powder form, for example.

The housing 42, the cap 44, or both may be designed to melt, rupture or otherwise deform to release the thermal suppression agent 46 when exposed to temperatures that exceed a predefined temperature threshold (e.g., between 150 and 250 degrees Celsius). Such temperatures may be present, for example, when one or more battery cells 24 near the thermal suppression container 34 is venting the vent byproducts 36. Once released, the thermal suppression agent 46 may capture or trap particles associated with the vent byproducts 36, thereby managing or even preventing the transfer of thermal energy toward the non-venting battery cells 24 of the cell stack 30 (schematically illustrated at reference numeral 99 in FIG. 2). The non-ruptured thermal suppression containers 34 may also reduce movement of the vent byproducts 36 toward the non-venting battery cells 24 of the cell stack 30.

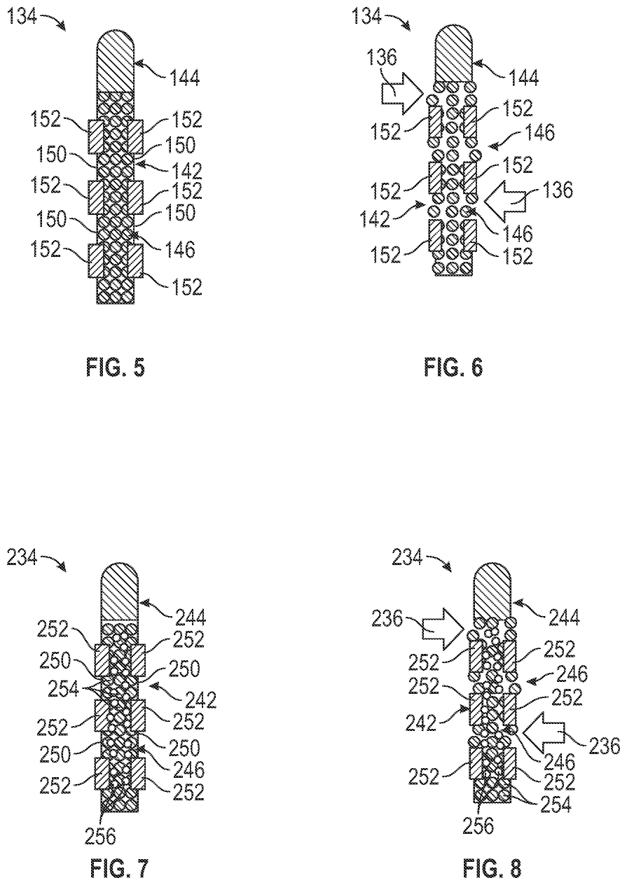

FIGS. 5 and 6 illustrate another exemplary thermal suppression container 134 that could be utilized as part of a thermal suppression system of a battery array. The thermal suppression container 134 may include a housing 142, a cap 144, and a thermal suppression agent 146 contained within the housing 142 by the cap 144. The housing 142 may include any shape (e.g., cylindrical, rectangular, spherical, etc.) and may be made of a polymeric material (e.g., polypropylene, polyethylene, etc.).

The cap 144 may include any shape (e.g., oval, long oval, trapezoidal, etc.) and may be made from the same material or a different material than the housing 142. The cap 144 may be made of polypropylene, silicone, ethylene propylene diene monomer (EPDM) rubber, thermoplastic elastomer (TPE), etc.

The thermal suppression agent 146 may be held within a hollow interior volume established by the housing 142. The thermal suppression agent 146 may be made of a high temperature material such as solid silica, aerogel, mica, basalt, etc. The thermal suppression agent 146 may be provided in either bead or powder form, for example.

The housing 142 may include thinned wall sections 150 interspersed between non-thinned wall sections 152 to provide a varying wall thickness within the housing 142. The thinned wall sections 150 may be made of the same material or a different material than the non-thinned wall sections 152. For example, the thinned wall sections 150 could be established by a film that is secured between non-thinned wall sections 152 of the housing 142.

The thinned wall sections 150 may be designed to melt, rupture, or otherwise deform prior to the non-thinned wall sections 152 in order to release the thermal suppression agent 146 from the housing 142 in a specific direction when exposed to temperatures that exceed a predefined temperature threshold (e.g., between 150 and 250 degrees Celsius). Such temperatures may be present, for example, when one or more battery cells placed near the thermal suppression container 134 are venting vent byproducts 136 (see FIG. 6). Once released, the thermal suppression agent 146 may capture or trap particles associated with the vent byproducts 136, thereby managing or even preventing the transfer of thermal energy toward non-venting battery cells within a cell stack of a battery array.

FIGS. 7 and 8 illustrate another exemplary thermal suppression container 234 that could be utilized as part of a thermal suppression system of a battery array. The thermal suppression container 234 may include a housing 242, a cap 244, and a thermal suppression agent 246 contained within the housing 242 by the cap 244. The housing 242 may include any shape (e.g., cylindrical, rectangular, spherical, etc.) and may be made of a polymeric material (e.g., polypropylene, polyethylene, etc.).

The cap 244 may include any shape (e.g., oval, long oval, trapezoidal, etc.) and may be made from the same material or a different material than the housing 242. The cap 244 may be made of polypropylene, silicone, ethylene propylene diene monomer (EPDM) rubber, thermoplastic elastomer (TPE), etc.

The thermal suppression agent 246 may be held within a hollow interior volume established by the housing 242. The thermal suppression agent 246 may be made of a high temperature material system that includes a mixture of both silica beads 254 and dielectric fluid filled beads 256 (e.g., dielectric liquid component inside a non-porous outer shell).

The housing 242 may include thinned wall sections 250 interspersed between non-thinned wall sections 252 to provide the housing 242 with a varying thickness. The thinned wall sections 250 may be made of the same material or a different material than the non-thinned wall sections 252. For example, the thinned wall sections 250 could be established by a film that is secured between non-thinned wall sections 252 of the housing 242.

The thinned wall sections 250 may be designed to melt, rupture, or otherwise deform prior to the non-thinned wall sections 252 in order to release the thermal suppression agent 246 in a specific direction when exposed to temperatures that exceed a predefined temperature threshold (e.g., between 150 and 250 degrees Celsius). Such temperatures may be present, for example, when one or more battery cells placed near the thermal suppression container 234 are venting vent byproducts 236 (see FIG. 8). Once released, the silica beads 254 of the thermal suppression agent 246 may capture or trap particles associated with the vent byproducts 236, thereby managing or even preventing the transfer of thermal energy toward non-venting battery cells of a cell stack, and the dielectric fluid filled beads 256 of the thermal suppression agent 246 may help reduce the temperature of the vent byproducts 236 and increase electrical isolation.

Although the thermal suppression agent 246 is described above as being contained with a housing having thinned wall sections, other configurations are contemplated within the scope of this disclosure. For example, the thermal suppression agent 246 could alternatively be utilized in combination with a housing having a design similar to the housing 42 of the thermal suppression container 34 of FIGS. 3-4.

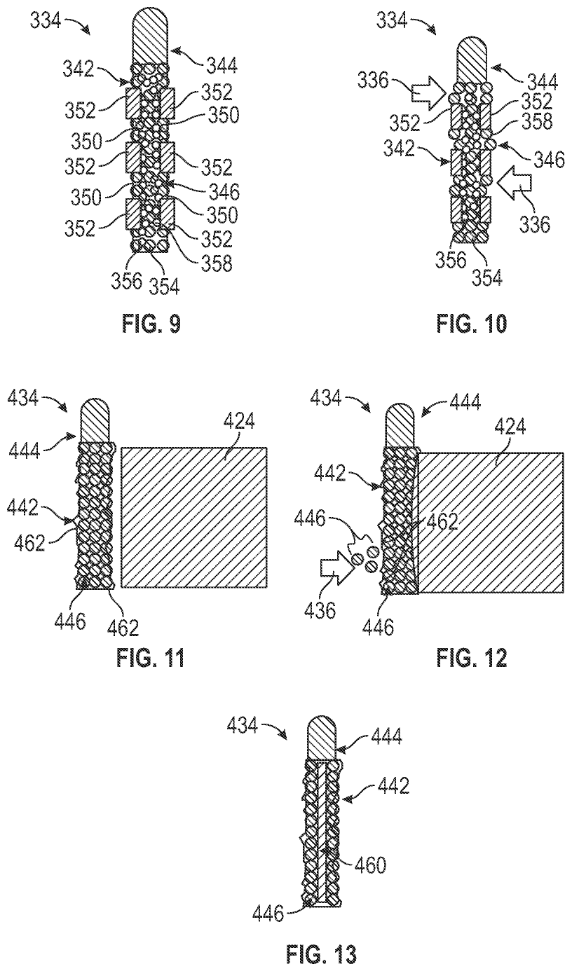

FIGS. 9 and 10 illustrate another exemplary thermal suppression container 334 that could be utilized as part of a thermal suppression system of a battery array. The thermal suppression container 334 may include a housing 342, a cap 344, and a thermal suppression agent 346 contained within the housing 342 by the cap 344. The housing 342 may include any shape (e.g., cylindrical, rectangular, spherical, etc.) and may be made of a suitable polymeric material (e.g., polypropylene, polyethylene, etc.).

The cap 344 may include any shape (e.g., oval, long oval, trapezoidal, etc.) and may be made from the same material or a different material than the housing 342. The cap 344 may be made of polypropylene, silicone, ethylene propylene diene monomer (EPDM) rubber, thermoplastic elastomer (TPE), etc.

The thermal suppression agent 346 may be held within a hollow interior volume established by the housing 342. The thermal suppression agent 346 may be made of a high temperature material system that includes a mixture of silica beads 354, dielectric fluid filled beads 356, and expandable foam beads 358.

The housing 342 may include thinned wall sections 350 interspersed between non-thinned wall sections 352 to provide the housing 342 with a varying thickness. The thinned wall sections 350 may be made of the same material or a different material than the non-thinned wall sections 352. For example, the thinned wall sections 350 could be established by a film that is secured between non-thinned wall sections 352 of the housing 342.

The thinned wall sections 350 may be designed to melt, rupture, or otherwise deform prior to the non-thinned wall sections 352 in order to release the thermal suppression agent 346 in a specific direction when exposed to temperatures that exceed a predefined temperature threshold (e.g., between 150 and 250 degrees Celsius). Such temperatures may be present, for example, when one or more battery cells placed near the thermal suppression container 334 release the vent byproducts 336. Once released, the silica beads 354 of the thermal suppression agent 346 may capture or trap particles associated with the vent byproducts 336, thereby managing or even preventing the transfer of thermal energy toward non-venting battery cells of a cell stack, the dielectric fluid filled beads 356 of the thermal suppression agent 346 may help reduce the temperature of the vent byproducts 336 and increase electrical isolation, and the expandable foam beads 358 of the thermal suppression agent 346 may expand to provide intumescent activation and to fill the void space of the battery array, thereby limiting convective heat transfer of the thermal energy across the battery array.

Although the thermal suppression agent 346 is described above as being contained with a housing having thinned wall sections, other configurations are contemplated within the scope of this disclosure. For example, the thermal suppression agent 346 could alternatively be utilized in combination with a housing similar to the housing 42 of the thermal suppression container 34 of FIGS. 3-4.

FIGS. 11, 12, and 13 illustrate another exemplary thermal suppression container 434 that could be utilized as part of a thermal suppression system of a battery array. The thermal suppression container 434 may include a housing 442, a cap 444, and a thermal suppression agent 446 contained within the housing 442 by the cap 444.

The housing 442 may be made of a flexible material that is configured to change shape to accommodate expansion of a nearby battery cell 424. For example, the housing 442 could be made of a foam material (e.g., polyurethane foam, silicone foam, etc.) that can alter its shape to accommodate the expansion of the battery cell 424. The housing 442 may additionally include a structural support 460 (see FIG. 13) for providing increased stiffness during installation of the thermal suppression container 434 within a void space of a battery array.

The cap 444 may include any shape (e.g., oval, long oval, trapezoidal, etc.) and may be made from the same material or a different material than the housing 442. The cap 444 may be made of polypropylene, silicone, ethylene propylene diene monomer (EPDM) rubber, thermoplastic elastomer (TPE), etc.

The thermal suppression agent 446 may be held within a hollow interior volume established by the housing 442. In an embodiment, the thermal suppression agent 446 is contained within a plurality of pockets 462 provided by the housing 442. The thermal suppression agent 446 may be made of a high temperature material system that includes one or more of solid silica, aerogel, mica, basalt, etc. The thermal suppression agent 446 may be provided in either bead or powder form, for example.

The housing 442, the cap 444, or both may be designed to melt, rupture, or otherwise deform to release the thermal suppression agent 446 when exposed to temperatures that exceed a predefined temperature threshold (e.g., between 150 and 250 degrees Celsius). Such temperatures may be present, for example, when one or more battery cells near the thermal suppression container 434 is venting the vent byproducts 436 (see FIG. 12). Once released, the thermal suppression agent 446 may capture or trap particles associated with the vent byproducts 436, thereby managing or even preventing the transfer of thermal energy toward non-venting battery cells of the cell stack.

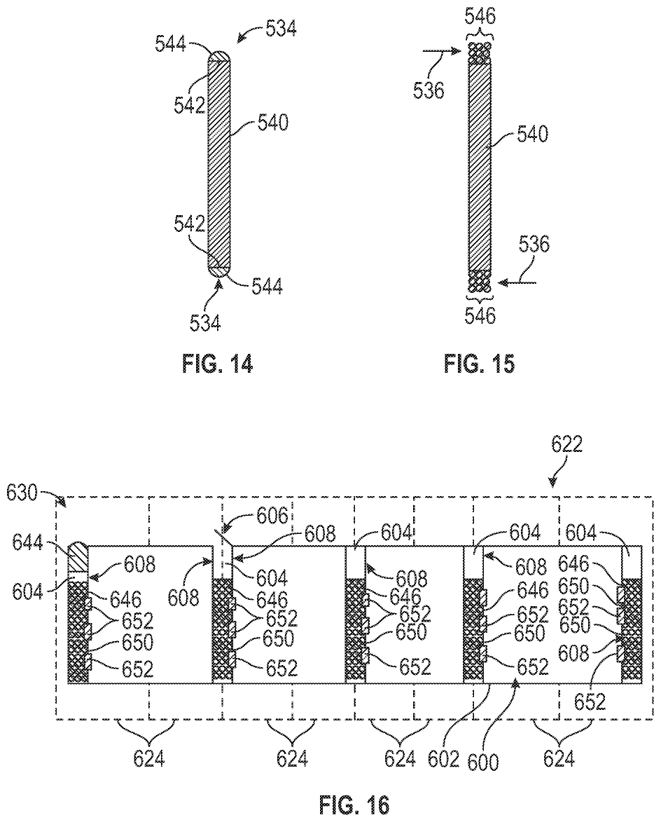

FIGS. 14 and 15 illustrate another exemplary thermal suppression container 534 that could be utilized as part of a thermal suppression system of a battery array. In this embodiment, the thermal suppression container 534 is attached to or integrated with a cell-to-cell barrier 540 of a cell stack of a battery array. One thermal suppression container 534 may be provided on each opposing side of the cell-to-cell barrier 540, for example.

Each thermal suppression container 534 may include a housing 542, a cap 544, and a thermal suppression agent 546 (see FIG. 15) contained within the housing 542 by the cap 544. The housing 542 may include any shape (e.g., cylindrical, rectangular, spherical, etc.) and may be made of a suitable polymeric material (e.g., polypropylene, polyethylene, etc.). The cap 544 may include any shape (e.g., oval, long oval, trapezoidal, etc.) and may be made from the same material or a different material than the housing 542. The cap 544 may be made of polypropylene, silicone, ethylene propylene diene monomer (EPDM) rubber, thermoplastic elastomer (TPE), etc.

The thermal suppression agent 546 may be held within a hollow interior volume established by the housing 542. The thermal suppression agent 546 may be made of a high temperature material system such as solid silica, aerogel, mica, basalt, etc. The thermal suppression agent 546 may be provided in either bead or powder form, for example.

The housing 542, the cap 544, or both may be designed to melt, rupture, or otherwise deform to release the thermal suppression agent 546 when exposed to temperatures that exceed a predefined temperature threshold (e.g., between 150 and 250 degrees Celsius). Such temperatures may be present, for example, when one or more battery cells near the thermal suppression container 534 vents the vent byproducts 536. Once released, the thermal suppression agent 546 may capture or trap particles associated with the vent byproducts 536, thereby managing or even preventing the transfer of thermal energy toward non-venting battery cells of the cell stack.

FIG. 16 illustrates a bus bar module 600 for electrically connecting battery cells 624 of a cell stack 630 of a battery array 622. The bus bar module 600 may include a frame 602 that is configured to hold a plurality of bus bars (not shown). The frame 602 may be positioned near the cell stack 630 for electrically connecting the battery cells 624.

The frame 602 of the bus bar module 600 may include a plurality of pockets 604. A thermal suppression agent 646 may be contained within an interior volume provided by each of the pockets 604. A cap 644 or a hinged lid 606 that is integrated with the frame 602 may hold the thermal suppression agent 646 within the pockets 604.

The thermal suppression agent 646 may be made of a high temperature material such as solid silica, aerogel, mica, basalt, etc. The thermal suppression agent 646 may be provided in either bead or powder form, for example. In another embodiment, the thermal suppression agent 646 includes a mixture of silica beads and dielectric fluid filled beads. In yet another embodiment, the thermal suppression agent 646 includes a mixture of silica beads, dielectric fluid filled beads, and expandable foam beads.

At least one wall 608 of each pocket 604 may include thinned wall sections 650 interspersed between non-thinned wall sections 652 to provide a varying thickness within the wall 608. The thinned wall sections 650 may be made of the same material or a different material than the non-thinned wall sections 652. For example, the thinned wall sections 650 could be established by a film that is secured between non-thinned wall sections 652 of the wall 608.

The thinned wall sections 650 may be designed to melt, rupture, or otherwise deform prior to the non-thinned wall sections 652 in order to release the thermal suppression agent 646 in a specific direction when exposed to temperatures that exceed a predefined temperature threshold (e.g., between 150 and 250 degrees Celsius). Such temperatures may be present, for example, when one or more battery cells 624 near the bus bar module 600 vents the vent byproducts. Once released, the thermal suppression agent 646 may capture or trap particles associated with the vent byproducts, thereby managing or even preventing the transfer of thermal energy toward non-venting battery cells 624 of the cell stack 630.

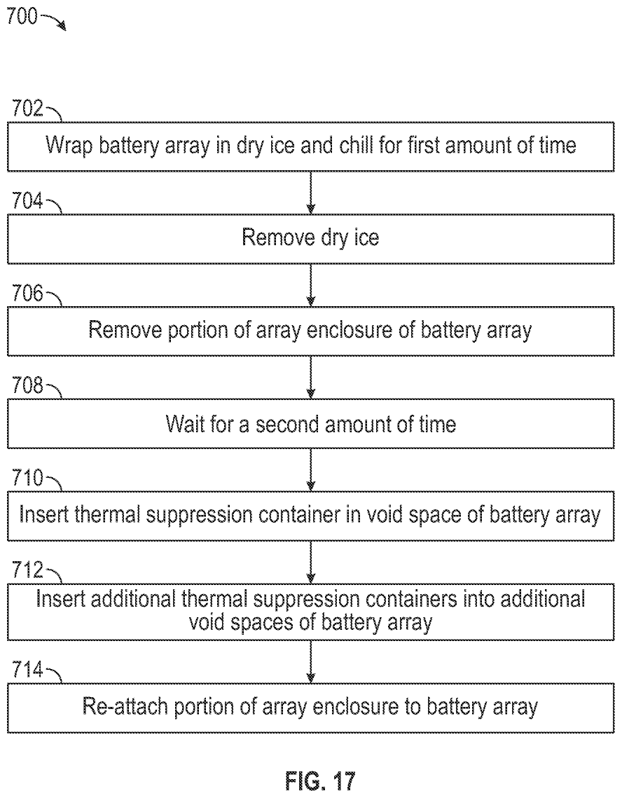

FIG. 17 schematically illustrates an exemplary method 700 for installing a thermal suppression system that includes a plurality of thermal suppression containers (e.g., any of the thermal suppression containers 34, 134, 243, 334, 434, 534) within a battery array of a traction battery pack. First, at block 702, the battery array may be wrapped in dry ice and chilled for a first amount of time (e.g., about 40 minutes). The dry ice may be removed at block 704, and a portion of an array enclosure (e.g., the bottom plate) of the battery array may be removed at block 706. At block 708, the method 700 may undergo a waiting period for a second amount of time (e.g., about 24 hours) during which the battery array is left undisturbed.

Next, at block 710, a thermal suppression container is inserted, cap-end first, into a void space of the battery array. The void space may extend between adjacent battery cell tab terminals, for example. Additional thermal suppression containers may subsequently be inserted into additional void spaces of the battery array at block 712. After ensuring that the thermal suppression containers are appropriately secured in place between the cell tab terminals and a thermal interface material of the battery array, the portion of the array enclosure previously removed at block 706 may be re-attached to the battery array at block 714.

The exemplary thermal suppression systems of this disclosure are designed to incorporate dispersible high temperature capable materials for mitigating the transfer of thermal energy across a battery array of a traction battery pack. The systems may provide numerous advantages over known solutions, including but not limited to presenting a novel configuration that significantly slows or even prevents the cell-to-cell transfer of the thermal energy.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery array; and
a thermal suppression container arranged within the battery array and configured to release a thermal suppression agent when a temperature near the thermal suppression container exceeds a predefined temperature threshold.

2. The traction battery pack as recited in claim 1, wherein the thermal suppression container is arranged to extend between a first cell tab terminal of a first battery cell and a second cell tab terminal of a second battery cell of the battery array.

3. The traction battery pack as recited in claim 1, wherein the thermal suppression container is arranged to extend between a cell tab terminal of a battery cell and a cell-to-cell barrier of the battery array.

4. The traction battery pack as recited in claim 1, wherein the thermal suppression container is attached to a cell-to-cell barrier of the battery array.

5. The traction battery pack as recited in claim 1, wherein the thermal suppression agent is contained within a housing of the thermal suppression container by a cap.

6. The traction battery pack as recited in claim 5, wherein the housing is configured to melt, rupture, or otherwise deform to release the thermal suppression agent.

7. The traction battery pack as recited in claim 5, wherein the housing includes a thinned wall section that is configured to melt, rupture, or otherwise deform prior to a non-thinned wall section of the housing to release the thermal suppression agent.

8. The traction battery pack as recited in claim 7, wherein the thinned wall section is made of a different material than the non-thinned wall section of the housing.

9. The traction battery pack as recited in claim 5, wherein the housing is made of a foam material that is configured to alter its shape in response to an expansion of a battery cell of the battery array.

10. The traction battery pack as recited in claim 9, wherein the housing includes a structural support.

11. The traction battery pack as recited in claim 5, wherein the housing includes a plurality of support feet adapted for positioning and securing the thermal suppression container within a void space of the battery array.

12. The traction battery pack as recited in claim 1, wherein the thermal suppression agent includes at least one of solid silica, aerogel, mica, or basalt.

13. The traction battery pack as recited in claim 1, wherein the thermal suppression agent includes a mixture of silica beads and dielectric fluid filled beads.

14. The traction battery pack as recited in claim 1, wherein the thermal suppression agent includes a mixture of silica beads, dielectric fluid filled beads, and expandable foam beads.

15. A traction battery pack, comprising:
a cell stack including a plurality of battery cells;
a bus bar module arranged to electrically connect the plurality of battery cells, wherein the bus bar module includes a frame having a first pocket; and
a first thermal suppression agent received within the first pocket.

16. The traction battery pack as recited in claim 15, wherein the first thermal suppression agent includes at least one of solid silica, aerogel, mica, or basalt.

17. The traction battery pack as recited in claim 15, wherein the first thermal suppression agent includes a mixture of silica beads and dielectric fluid filled beads.

18. The traction battery pack as recited in claim 15, wherein the first thermal suppression agent includes a mixture of silica beads, dielectric fluid filled beads, and expandable foam beads.

19. The traction battery pack as recited in claim 15, comprising a second thermal suppression agent received within a second pocket of the frame.

20. A method of installing a thermal suppression system within a battery array for a traction battery pack, comprising:
chilling the battery array for a first amount of time;
waiting for a second amount of time after chilling the battery array; and
inserting a thermal suppression container into a void space of the battery array after waiting for the second amount of time.
